(19) United States
(12) Patent Application Publication
(10) Pub. No.: US 2015/0377421 A1
(43) Pub. Date: Dec. 31, 2015

(54) Omni-Directional LED Bulb Lamp

(71) Applicant: FORMOSA OPTRONICS CO., LTD., New Taipei City (TW)

(72) Inventor: TSAN-JUNG CHEN, New Taipei City (TW)

(21) Appl. No.: 14/747,055

(22) Filed: Jun. 23, 2015

(30) Foreign Application Priority Data
Jun. 27, 2014 (TW) 103122349

(51) Int. Cl. F21K 99/00; F21V 29/50; F21V 23/06

(52) U.S. Cl. CPC F21K 9/135; F21V 23/06; F21V 29/50; F21Y 2101/02

(57) ABSTRACT

The present invention provides an omni-directional LED bulb lamp, wherein the omni-directional LED bulb lamp mainly consists of: a main body, a standard connector, a LED disposing body, a copper circuit layer, an anti-soldering layer, a plurality of LED chips, and a cover. Particularly, the LED disposing body is designed to comprise a main disposing portion, a first folding portion and a second folding portion; moreover, the first folding portion and the main disposing portion have a first included angle, and the second folding portion and the first folding portion have a second included angle. By such design, when the LED chips disposed on the main disposing portion, the first folding portion and the second folding portion emit light, the illumination range of the emitted light is able to be greater than 270°.

### BACKGROUND OF THE INVENTION

1. Field of the Invention

The present invention relates to the technology field of LED lamps, and more particularly to an omni-directional led bulb lamp having a wide illumination range greater than 270°.

2. Description of the Prior Art

Recently, light-emitting diodes (LEDs) are widely used as the lighting apparatus in human life. Please refer to FIG. 1, which illustrate a stereo view of a conventional LED bulb lamp. As FIG. 1 shows, the conventional LED bulb lamp 1′ mainly consists of: a main body 11′, a base 12′ and a cover 13′, wherein the main body 11′ is provided with a substrate 14′ on the top thereof, and a plurality of LED chips 15′ are welded on the substrate 14′. In spite of the conventional LED bulb lamp 1′ having a primary advantage of simple constitution structure, the conventional LED bulb lamp 1′ also has a denounced drawback of narrow illumination range. As shown in FIG. 1, the illumination range of the conventional LED bulb lamp 1′ is at most 120°.

For the conventional LED bulb lamp 1′ showing the denounced drawback of narrow illumination range, LED lamp manufacturers therefore develops and proposes an improved LED bulb lamp. Please refer to FIG. 2, there is shown a stereo view of the said improved LED bulb lamp. As FIG. 2 shows, the improved LED bulb lamp 1″ consists of: a main body 11″, a base 12″ and a cover 17″, wherein the base 12″ is a cylinder disposed on the main body 11″ vertically, and has a top LED-disposing portion 13″ and at least one lateral LED-disposing portion 14″. Moreover, a plurality of top LED chips 15″ are welded on the top LED-disposing portion 13″, and a plurality of lateral LED chips 16″ are welded on the lateral LED-disposing portion 14″.

From FIG. 2, the person skilled in LED lamp technology can find that, the effective illumination range of the improved LED bulb lamp 1″ is enlarged because the top LED chips 15″ and the lateral LED chips 16″ are respectively disposed on the top LED-disposing portion 13″ and the lateral LED-disposing portion 14″.

From above descriptions, it can also know that the illumination range of the improved led bulb lamp 1″ is wider than the conventional LED bulb lamp 1′ shown in FIG. 1. However, when practically applying the omni-directional led bulb lamp 1″, the inventor of the present invention still finds a primary drawback of the improved led bulb lamp 1″. That is, although the illumination range of the improved led bulb lamp 1″ is wider than the conventional LED bulb lamp 1′ shown in FIG. 1, the illumination range of the improved led bulb lamp 1″, the improved led bulb lamp 1″ still cannot be an omni-directional LED bulb lamp; the reason is that the light emitted by the improved led bulb lamp 1″ shows weaker illumination intensity in a particular illumination angle of 90°-130°.

Accordingly, in view of the conventional LED bulb lamp 1′ and the improved LED bulb lamp 1″ still have the drawbacks and shortcomings, the inventor of the present application has made great efforts to make inventive research thereon and eventually provided an omni-directional LED bulb lamp.

### SUMMARY OF THE INVENTION

The primary objective of the present invention is to provide an omni-directional LED bulb lamp, wherein the omni-directional LED bulb lamp mainly consists of: a main body, a standard connector, a LED disposing body, a copper circuit layer, an anti-soldering layer, a plurality of LED chips, and a cover. Particularly, the LED disposing body is designed to comprise a main disposing portion, a first folding portion and a second folding portion; moreover, the first folding portion and the main disposing portion have a first included angle, and the second folding portion and the first folding portion have a second included angle. By such design, when the LED chips disposed on the main disposing portion, the first folding portion and the second folding portion emit light, the illumination range of the emitted light is able to be greater than 270°.

Accordingly, in order to achieve the primary objective of the present invention, the inventor of the present invention provides an omni-directional LED bulb lamp, comprising:

a main body;

a standard connector, connected to the bottom of the main body;

an LED disposing body, attached on the top of the main body and having a main disposing portion, a first folding portion adjacently connected with the main disposing portion, and a second folding portion adjacently connected with the first folding portion; wherein the first folding portion and the main disposing portion have a first included angle, and the second folding portion and the first folding portion having a second included angle;

a copper circuit layer, attached on the main disposing portion, the first folding portion and the second folding portion through a thermal conductive and electric insulating adhesive; wherein the copper circuit layer is electrically connected with a circuit controlling unit and has a plurality of soldering electrodes;

an anti-soldering layer, formed on the LED disposing body for covering the copper circuit layer, wherein the anti-soldering layer has a plurality of soldering openings for facilitating the soldering electrodes be exposed out of the anti-soldering layer;

a plurality of LED chips, disposed on the anti-soldering layer, and welded with the soldering electrodes via the soldering openings; and

a cover, connected to the main body for protecting the LED disposing body, the copper circuit layer, the anti-soldering layer, and the LED chips.

### BRIEF DESCRIPTION OF THE DRAWINGS

The invention as well as a preferred mode of use and advantages thereof will be best understood by referring to the following detailed description of an illustrative embodiment in conjunction with the accompanying drawings, wherein:

FIG. 1 is a stereo view of a conventional LED bulb lamp;

FIG. 2 is a stereo view of the said improved LED bulb lamp;

FIG. 3 is a stereo view of an omni-directional LED bulb lamp;

FIG. 4 shows stereo diagrams of a copper circuit layer, an anti-soldering layer, and a plurality of LED chips;

FIG. 5 is a side view of an LED disposing body;

FIG. 6 shows a stereo view of a second exemplary embodiment for the copper circuit layer, the anti-soldering layer, and the plurality of LED chips;

FIG. 7A is a cross sectional view of the LED chip;

FIG. 7B is a cross sectional view of the LED chip;

FIG. 7C is a cross sectional view of the LED chip;

FIG. 7D is a cross sectional view of the LED chip;

FIG. 8 shows a stereo view of a second exemplary embodiment for a main body and the LED disposing body of the omni-directional LED bulb lamp;

FIG. 9 shows a data plot of light intensity distribution measured from the improved LED bulb lamp presented by FIG. 2; and

FIG. 10 shows a second data plot of light intensity distribution measured from the omni-directional LED bulb lamp.

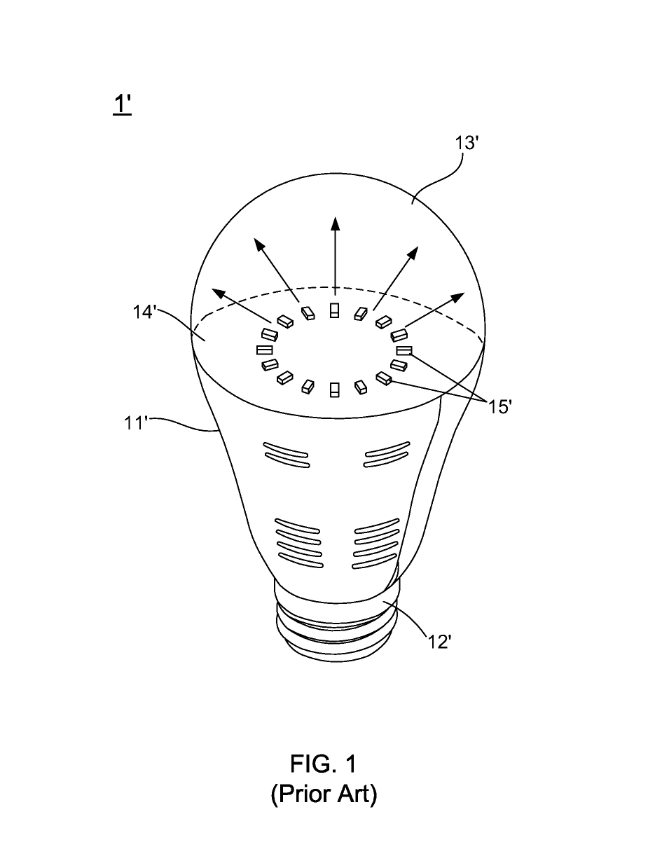

### DETAILED DESCRIPTION OF THE PREFERRED EMBODIMENTS

To more clearly describe an omni-directional LED bulb lamp according to the present invention, embodiments of the present invention will be described in detail with reference to the attached drawings hereinafter.

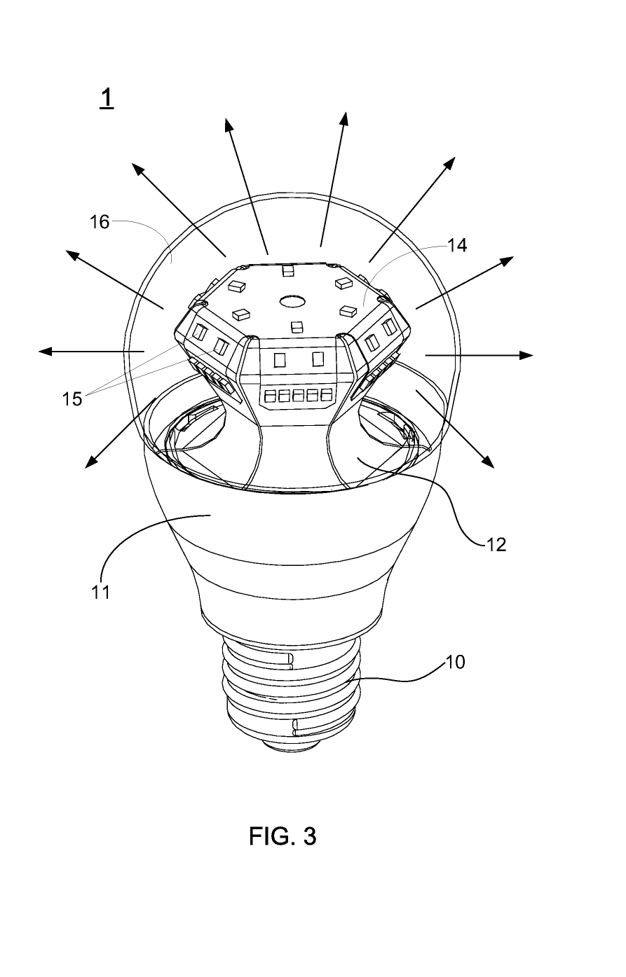

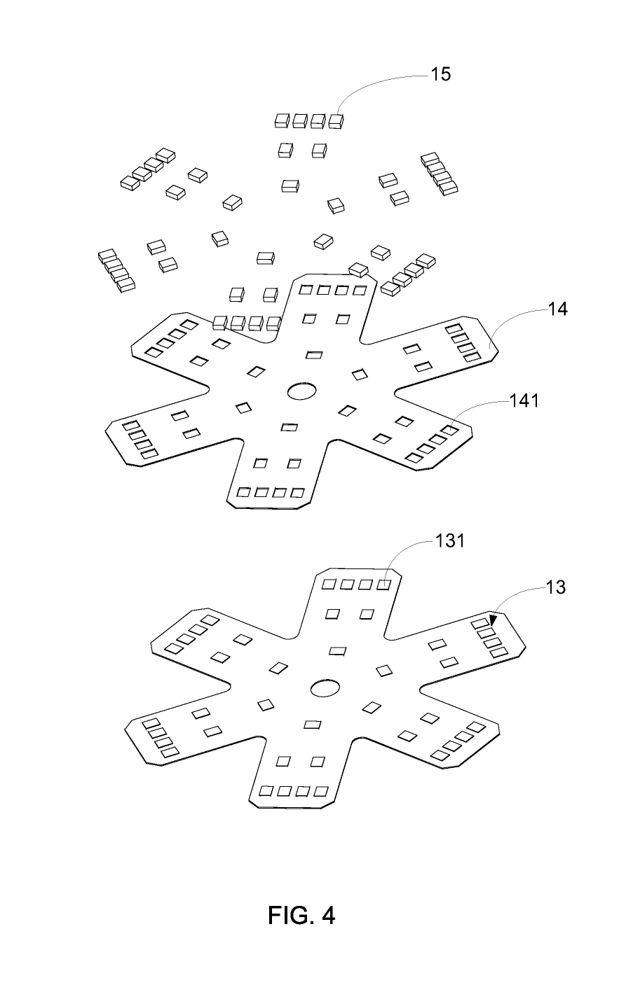

Please refer to FIG. 3, where a stereo view of an omni-directional LED bulb lamp according to the present invention is shown. Moreover, please simultaneously refer to FIG. 4, which shows the stereo diagram of a copper circuit layer, an anti-soldering layer, and a plurality of LED chips in the omni-directional LED bulb lamp. As FIG. 3 and FIG. 4 show, the omni-directional LED bulb lamp 1 mainly consists of: a main body 11, a standard connector 10, an LED disposing body 12, a copper circuit layer 13, an anti-soldering layer 14, a plurality of LED chips 15, and a cover 16. In which, the standard connector 10 is connected to the bottom of the main body 11. Opposite to the standard connector 10, the LED disposing body 12 is attached on the top of the main body 11, and a thermal conductive medium is disposed between the LED disposing body 12 and the main body 11, used for accelerating the heat in the LED disposing body 12 being transmitted to the main body 11.

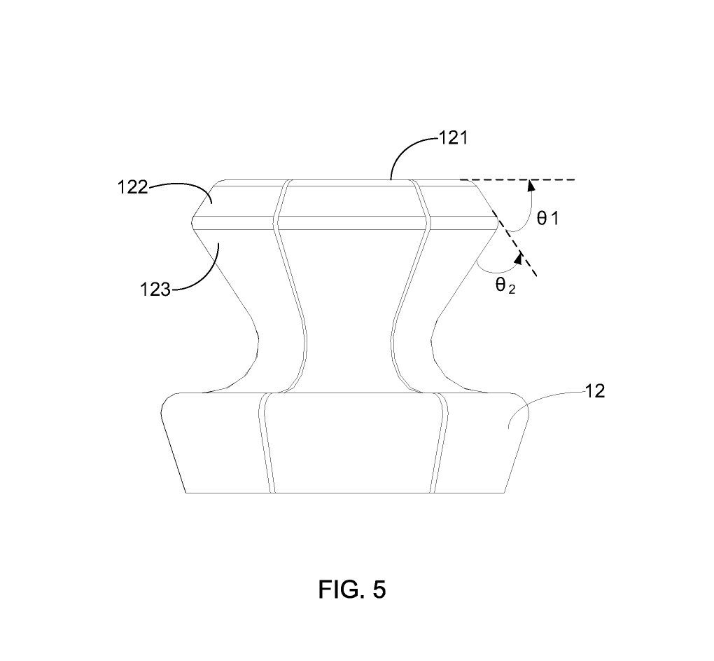

Continuously referring to FIG. 3 and FIG. 4, and please simultaneously refer to FIG. 5, there is shown side view of an LED disposing body. In the present invention, the LED disposing body 12 shows a diamond-like-shape, and is particularly designed to be consisted of a main disposing portion 121, a first folding portion 122 adjacently connected with the main disposing portion 121, and a second folding portion 123 adjacently connected with the first folding portion 122. In which, the first folding portion 122 and the main disposing portion 121 have a first included angle θ1 ranged from 45° to 75°, and the second folding portion 123 and the first folding portion 122 have a second included angle θ2 ranged from 45° to 75°.

In the present invention, the main body 11 is made of a metal material or a heat-conductive plastic material. Moreover, the metal-made main body 11 needs to be further covered by a plastic cover, so as to present the metal-made main body 11 from being directly touched by external objects. In addition, the LED disposing body 12 attached on the top of the main body 11 is formed by bending and folding a metal sheet. The copper circuit layer 13 is attached on the main disposing portion 121, the first folding portion 122 and the second folding portion 123 through a thermal conductive and electric insulating adhesive; moreover, the copper circuit layer 13 is electrically connected with a circuit controlling unit and has a plurality of soldering electrodes 131.

Inheriting to above descriptions, the anti-soldering layer 14 is formed on the LED disposing body 12 for covering the copper circuit layer 13, wherein the anti-soldering layer 14 has a plurality of soldering openings 141 for facilitating the soldering electrodes 131 be exposed out of the anti-soldering layer 14. The anti-soldering layer 14 is a white paint having light reflective and heat disappearing functionality; moreover, the white paint being extendedly coated onto the outer surface and the inner surface of the LED disposing body 12, so as to enhance the heat disappearing ability of the LED disposing body 12. Therefore, the LED chips 15 are disposed on the anti-soldering layer 14, and welded with the soldering electrodes 131 via the soldering openings 141. Eventually, the cover 16 is connected to the main body 11 for protecting the LED disposing body 12, the copper circuit layer 13, the anti-soldering layer 14, and the LED chips 15. In the present invention, the cover 16 can be a glass cover or a plastic cover. Moreover, the cover 16 can also be a transparent glass cover or a forsted glass cover. Besides, in order to enhance the light scattering, the aforesaid transparent cover (16) can be further provided with a light diffusion film on the inner surface thereof.

Herein, it needs to further explain the main function of the anti-soldering layer 14. Because the solder paste disposed on the soldering electrodes 131 may laterally flow when a reflow a reflow soldering process is executed, it is able to block the laterally-flowing solder paste from causing the short circuit of the copper circuit layer 13 after the said anti-soldering layer 14 is disposed between the copper circuit layer 13 and the LED chips 15. Therefore, the manufacturing yield of the LED bulb lamp can be effectively enhanced. Moreover, a fringing current preventing layer can be coated on the surface of the LED disposing body 12, and located between the LED disposing body 12 and the thermal conductive and electric insulating adhesive. Therefore, the voltage withstanding ability of the copper circuit layer and the LED chips 15 can be increased, such that the life time of the LED bulb lamp is then extended.

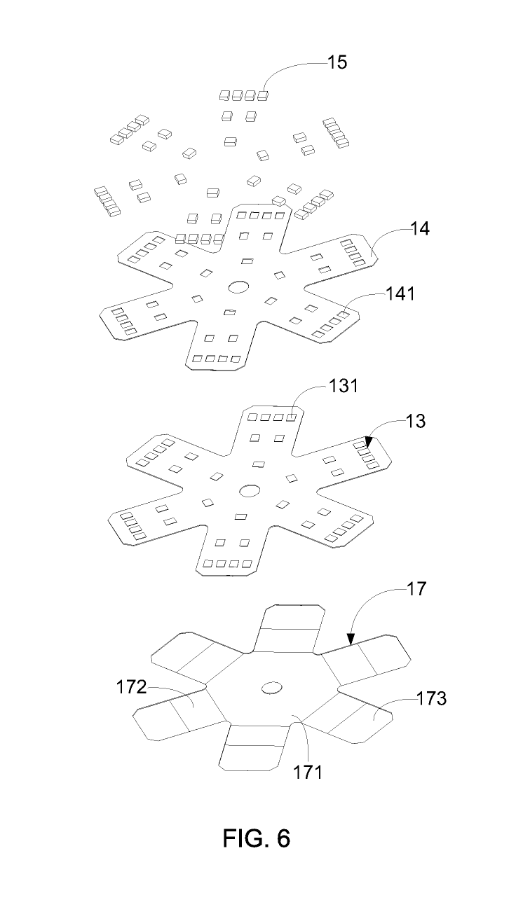

Please refer to FIG. 6, which illustrates a stereo view of a second exemplary embodiment for the copper circuit layer 13, the anti-soldering layer 14, and the plurality of LED chips 15. In the second exemplary embodiment of the copper circuit layer 13, the anti-soldering layer 14, and the plurality of LED chips 15, a substrate 17 is disposed on the LED disposing body 12, such that the copper circuit layer 13 is attached on the substrate 17 through the thermal conductive and electric insulating adhesive. In which, the manufacturing material of the substrate 17 can be aluminum, polypropylene (PP), polyimide (PI), polyethylene (PE), polycarbonate (PC), or ppolyethylene terephthalate (PET). Moreover, in the present invention, the said substrate 17 consists of: a main disposing region 171, a first folding region 172 and a second folding region 173, and the main disposing region 171, the first folding region 172 and the second folding region 173 are respectively opposite to the first disposing portion 122, the first folding portion 122 and the second folding portion 123.

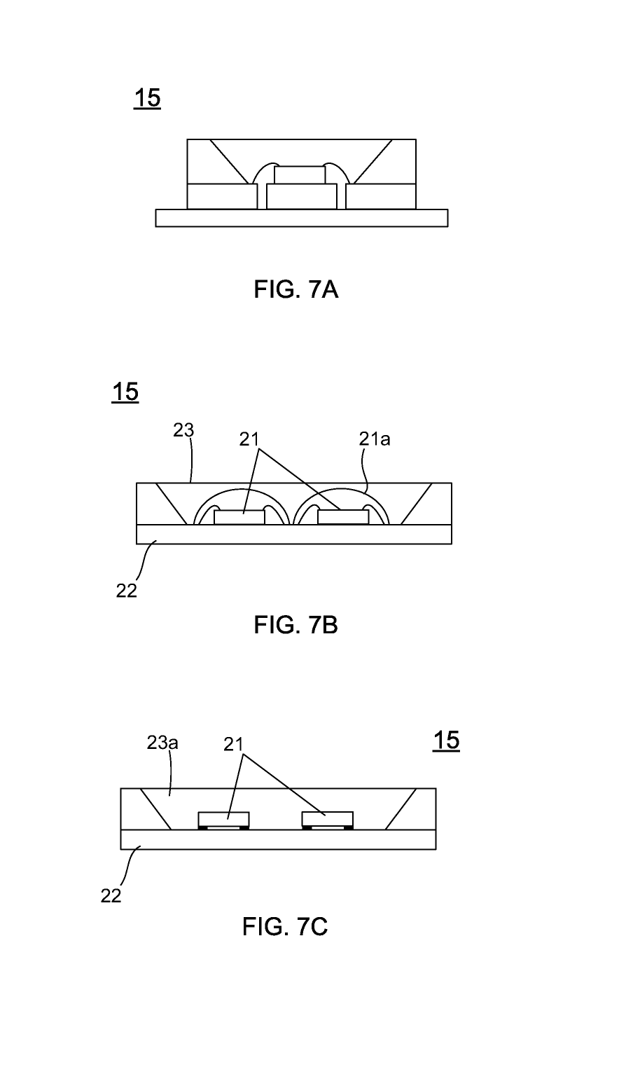

Continuously, please refer to FIG. 7A, FIG. 7B, FIG. 7C, and FIG. 7D, where different cross sectional views for the LED chip 15 are presented. As shown in FIG. 7A, the LED chip 15 is a face-up LED chip. In addition, the LED chip 15 shown by FIG. 7B is a chip-on-board (COB) LED chip, wherein the said chip-on-board LED chip 15 comprises: a leadframe substrate 22, at least one LED grain chip 21 disposed on the leadframe substrate 22, a transparent colloid 21a covering the LED grain chip 21, and a fluorescent colloid 23 covering the LED grain chip 21 and the transparent colloid 21a. Furthermore, as shown in FIG. 7C, the LED chip 15 can be a flip-chip LED, and the flip-chip LED comprises: a substrate 22, provided with a circuit layer on the surface thereof, at least one LED grain chip 21 welded to the circuit layer through at least two conductive wires, a transparent fluorescent colloid 23a, covering the LED grain chip 21.

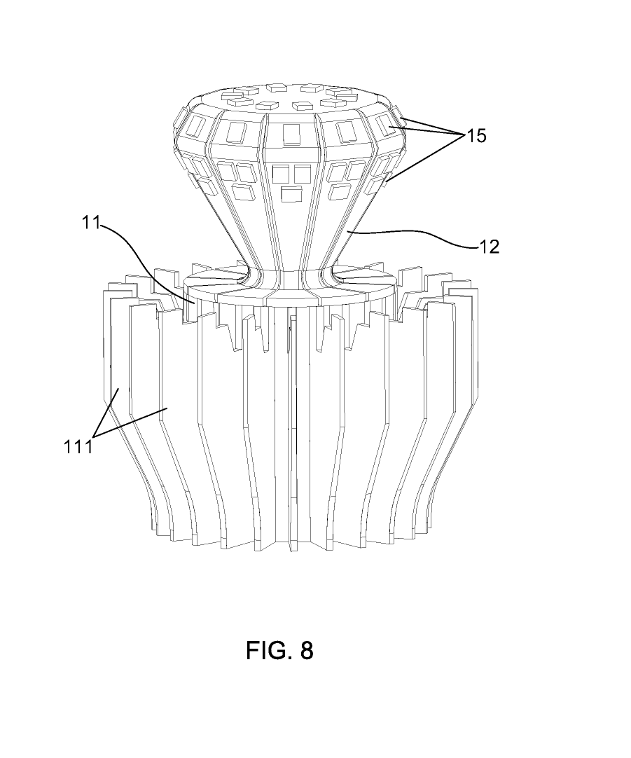

Please refer to FIG. 8, which illustrates a stereo view of a second exemplary embodiment for the main body 11 and the LED disposing body 12 of the omni-directional LED bulb lamp 1. As FIG. 8 shows, the main body 11 can be constituted by a plurality of fin sheets, wherein the LED disposing body 12 is attached onto a carrying surface of the main body 11 constituted by the fin sheets 11. By such design, when the heat accompanied by the lighting of the LED chips 15 would be firstly transmit from LED disposing body 12 to the main body 11 through the thermal conductive medium, and then the heat would be rapidly disappeared through the fin sheets.

Therefore, above descriptions have completely introduced all constituting elements and exemplary embodiments of the omni-directional LED bulb lamp 1 proposed by the present invention. In following paragraph, a variety of experimental data will be provided for proving the practicability of this omni-directional LED bulb lamp 1. According to the definitions made by American National Standards Institute (ANSI), the light intensity of the emitted light of the LED bulb lamp measured in the illumination range of 0°-90° cannot exceed the averaged light intensity of all emitted light of the LED bulb lamp by 25%; moreover, the light flux in in the illumination range of 135°-180° cannot lower than the total light flux of the LED bulb lamp by 5%.

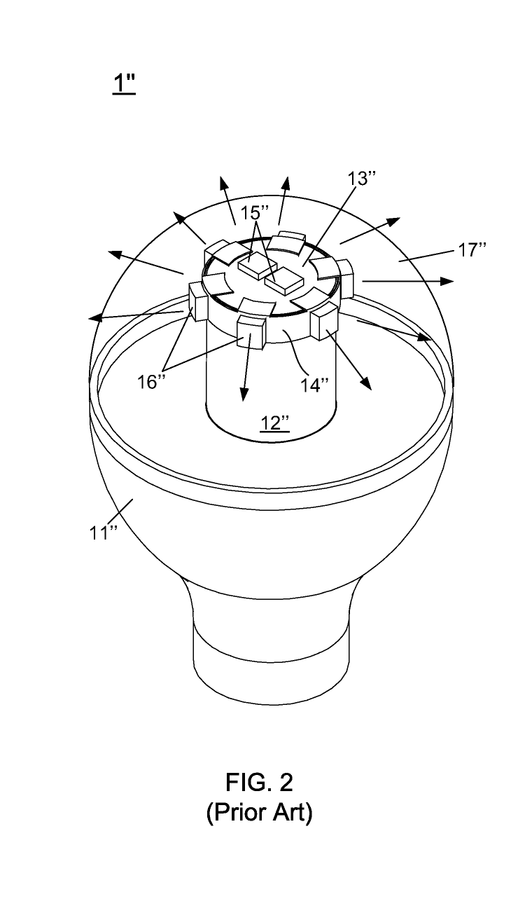

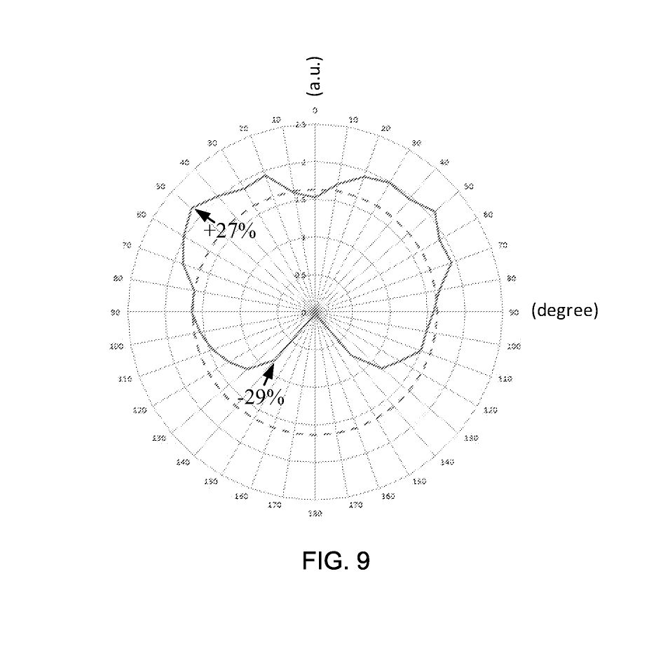

Please refer to FIG. 9, there is provided a data plot of light intensity distribution measured from the improved LED bulb lamp 1″ presented by FIG. 2. From FIG. 9, the person skilled in LED light device art can easily find that, the light intensity of the emitted light of the improved LED bulb lamp 1″ measured in the illumination range of 0°-90° does exceed the averaged light intensity of all emitted light of the improved LED bulb lamp 1″ by 25%; moreover, the light flux in in the illumination range of 135°-180° is lower than the total light flux of the improved LED bulb lamp 1″ by 29%.

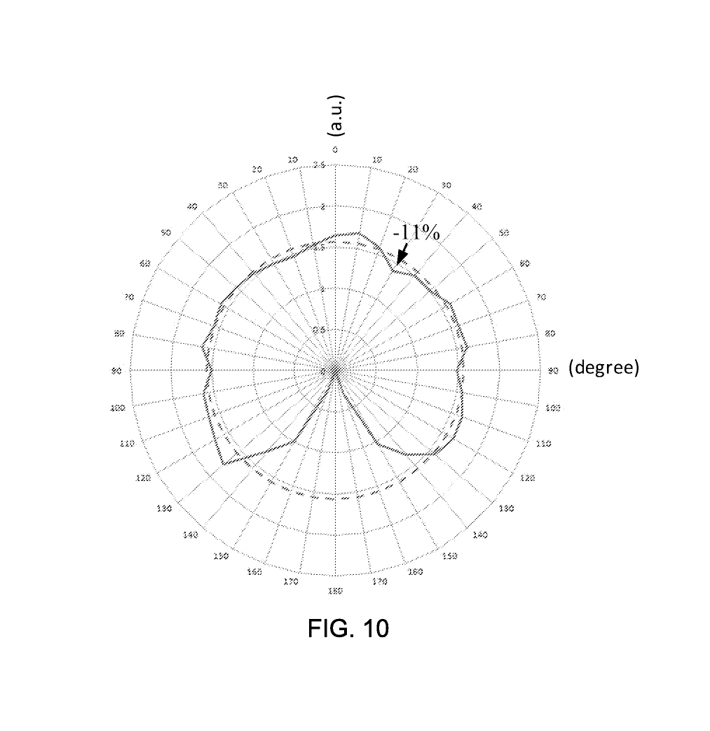

Continuously referring to FIG. 10, where a data plot of light intensity distribution measured from the omni-directional LED bulb lamp 1 is provided. From FIG. 10, the person skilled in LED light device art can easily find that, the light intensity of the emitted light of the omni-directional LED bulb lamp 1 measured in the illumination range of 0°-90° does exceed the averaged light intensity of all emitted light of the improved LED bulb lamp 1″ by only 11%; moreover, the light flux in in the illumination range of 135°-180° is lower than the total light flux of the omni-directional LED bulb lamp 1 by 5%.

The above description is made on embodiments of the present invention. However, the embodiments are not intended to limit scope of the present invention, and all equivalent implementations or alterations within the spirit of the present invention still fall within the scope of the present invention.

What is claimed is:

1. An omni-directional LED bulb lamp, comprising:
a main body;
a standard connector, being connected to the bottom of the main body;
an LED disposing body, being attached on the top of the main body, and having a main disposing portion, a first folding portion adjacently connected with the main disposing portion, and a second folding portion adjacently connected with the first folding portion; wherein the first folding portion and the main disposing portion have a first included angle, and the second folding portion and the first folding portion having a second included angle;
a copper circuit layer, being attached on the main disposing portion, the first folding portion and the second folding portion through a thermal conductive and electric insulating adhesive; wherein the copper circuit layer is electrically connected with a circuit controlling unit and has a plurality of soldering electrodes;
an anti-soldering layer, being formed on the LED disposing body for covering the copper circuit layer, wherein the anti-soldering layer has a plurality of soldering openings for facilitating the soldering electrodes be exposed out of the anti-soldering layer;
a plurality of LED chips, being disposed on the anti-soldering layer, and welded with the soldering electrodes via the soldering openings; and
a cover, being connected to the main body for protecting the LED disposing body, the copper circuit layer, the anti-soldering layer, and the LED chips.

2. The omni-directional LED bulb lamp of claim 1, wherein the LED disposing body is formed by bending and folding a metal sheet.

3. The omni-directional LED bulb lamp of claim 1, wherein a thermal conductive medium is disposed between the LED disposing body and the main body, used for accelerating the heat in the LED disposing body being transmitted to the main body.

4. The omni-directional LED bulb lamp of claim 1, wherein the LED disposing body shows a diamond-like-shape.

5. The omni-directional LED bulb lamp of claim 1, wherein the first included angle is ranged between 45° and 75°.

6. The omni-directional LED bulb lamp of claim 1, wherein the second included angle is ranged between 45° and 75°.

7. The omni-directional LED bulb lamp of claim 1, wherein the anti-soldering layer is a white paint having light reflective and heat disappearing functionality; moreover, the white paint being extendedly coated onto the outer surface and the inner surface of the LED disposing body, so as to enhance the heat disappearing ability of the LED disposing body.

8. The omni-directional LED bulb lamp of claim 1, wherein the LED chip 15 is selected from the group consisting of: face-up LED chip, flip-chip (F/C) LED chip, and chip-on-board (COB) LED chip.

9. The omni-directional LED bulb lamp of claim 1, wherein a fringing current preventing layer, being coated on the surface of the LED disposing body, and located between the LED disposing body and the thermal conductive and electric insulating adhesive.

10. The omni-directional LED bulb lamp of claim 1, further comprising a substrate 17 disposed on the LED disposing body, such that the copper circuit layer is attached on the substrate through the thermal conductive and electric insulating adhesive.

11. The omni-directional LED bulb lamp of claim 1, wherein the cover is a glass cover or a plastic cover.

12. The omni-directional LED bulb lamp of claim 1, wherein the cover is a transparent glass cover or a forsted glass cover.

13. The omni-directional LED bulb lamp of claim 1, wherein the main body 11 is made of a metal material or a heat-conductive plastic material.

14. The omni-directional LED bulb lamp of claim 8, wherein the said chip-on-board LED chip is formed by way of welding at least one LED grain chip onto a lead frame and using a fluorescent colloid to cover the LED grain chip and the lead frame.

15. The omni-directional LED bulb lamp of claim 8, wherein the said flip-chip LED comprising:
a leadframe substrate;
at least one LED grain chip, being disposed on the leadframe substrate;
a transparent colloid, covering the LED grain chip; and
a fluorescent colloid, covering the LED grain chip and the transparent colloid.

16. The omni-directional LED bulb lamp of claim 8, wherein the said flip-chip LED comprising:
a substrate, being provided with a circuit layer on the surface thereof;
at least one LED grain chip, being welded to the circuit layer through at least two conductive wires; and
a transparent fluorescent colloid, covering the LED grain chip.

17. The omni-directional LED bulb lamp of claim 10, wherein the substrate has a main disposing region, a first folding region and a second folding region respectively opposite to the first disposing portion, the first folding portion and the second folding portion.

18. The omni-directional LED bulb lamp of claim 10, wherein the substrate is selected from the group consisting of: aluminum substrate, polypropylene (PP) substrate, polyimide (PI) substrate, polyethylene (PE) substrate, polycarbonate (PC) substrate, and ppolyethylene terephthalate (PET) substrate.

19. The omni-directional LED bulb lamp of claim 12, wherein the aforesaid transparent cover is provided with a light diffusion film on the inner surface thereof.

20. The omni-directional LED bulb lamp of claim 13, wherein the metal-made main body is further covered by a plastic cover.
